(19) United States
(12) Patent Application Publication
(10) Pub. No.: US 2004/0045713 A1
(43) Pub. Date: Mar. 11, 2004

(54) Slurry for hydrocarbon production and water injection well cementing, and procedures to cement wells using such slurry

(76) Inventors: Gustavo Luis Bianchi, Neuquen (AR); Walter Morris, Neuquen (AR); Jose Andres Cacho, Neuquen (AR)

Correspondence Address: Attn: Albert B. Kimball, Jr., BRACEWELL & PATTERSON, L.L.P., P.O. BOX 61389, Houston, TX, 77208-1389, US

(21) Appl. No.: 10/373,008

(22) Filed: Feb. 24, 2003

(30) Foreign Application Priority Data
May 31, 2002 (AR) P020102056

(51) Int. Cl. E21B 33/14; C04B 16/12

(52) U.S. Cl. 166/293; 166/292; 166/295; 524/2; 106/819; 106/823

(57) ABSTRACT

A slurry for hydrocarbon production and water injection well cementing, and procedures to cement wells using such slurry are provided. The slurry contains at least cement and water, and at least an amount of fibers in a ratio of 0.1 to 0.8% in weight with respect to cement weight, where the fibers may in general be of polypropylene, polystyrene, carbon, alkali-resistant glass, cellulose or polymers. The slurry may also comprise other additives, such as dispersants, fluid loss agents, accelerators and retarders, chemical extenders and latex, among others. Procedures to cement hydrocarbon production wells or water injection wells are also described, where the cement slurry is prepared incorporating fibers into the slurry separately or mixing them with the remaining dry components before adding water.

### BACKGROUND OF THE INVENTION

1. Field of the Invention

The present invention provides a slurry for well cementing operations in hydrocarbon production wells and water injection wells, and processes to cement wells using such a slurry. More specifically, the present invention provides a slurry for cementing operations of hydrocarbon production or water injection wells that contains at least cement and water and that includes, at least, an amount of fibers in a ratio between 0.1 and 0.8% in weight with respect to cement weight. The fibers may in general be of polypropylene, polystyrene, carbon, alkali-resistant glass, cellulose or polymers. For example, the fibers may be 10-15 mm long polypropylene fibers.

2. Description of the Related Art

Well cementing is a well completion operation which involves filling the annular space existing between the casing and the geological formations that such casing goes through. The purposes of the operation are to form a seal between the different formations and the aquiferous elements that have become connected while drilling the well; to consolidate mechanically unstable formations; to eliminate mud residues and solid sediments generated while drilling; and to protect the casing against external corrosion in sections which are in contact with (chemically?) aggressive formations.

Cementing also allows protecting the well from collapses, water flow or filtrations or other drilling-related problems; it is done by injecting or pumping a cement slurry through the casing tubing, so that the cement moves upwards through the annular space, where it sets and becomes solid.

After the drilling, cementing and perforation processes are over, the well is left lined from the earth surface to well bottom, which ensures its continuity and facilitates oil extraction during the production process.

Regarding the slurry (cement+water+additives), it is necessary to achieve a consistency that enables pumping of slurry to the required well depths before the slurry sets, under the extreme temperature and pressure conditions present at that well depth.

In the recent years, new additives and materials have been developed to improve cement performance in the presence of certain factors, such as gas migration; slurry density, compression, impact and tensile resistance; as well as friction and filtration strength. For this reason, slurries which are being used often contain, among others, additives such as retardants, dispersants, densifiers, filtration and fluid loss controllers, used to obtain a kind of slurry that meets the optimum performance requirements.

One of the inconveniences that still remains unsolved when these materials are used, relates to faults caused by damages in cementation occurring when carrying out perforation or stimulation operations or by stress conditions generated by geological formation movements during life of the well. Such faults bring about different problems that range from communication between formations of interest by cement fissures, to loss of bonding between the cement and the formation, cement crumbling, obstruction of the perforation holes and, in some cases, casing collapse due to mechanical intrusions caused by the formation.

Some attempts to improve cement properties in presence of these kinds of problems have included the implementation of latex-based additives to improve material elasticity or the use of bentonite to improve its plasticity. However, so far as is known, none of these products has achieved a satisfactory response to the problems mentioned above.

### SUMMARY OF THE INVENTION

The present invention provides a slurry for hydrocarbon production well cementing, containing at least cement and water, and comprising an amount of fibers in a ratio of 0.1 to 0.8% in weight with respect to cement weight, where the fibers may be of polypropylene, polystyrene, carbon, alkali-resistant glass, cellulose or polymers or the like. The preferred slurry preferably includes 10-15 mm long polypropylene fibers. The slurry of the present invention may also include other commonly used additives such as dispersants, fluid loss agents, accelerators and retarders, friction reducers, extenders, latex or combinations of these.

Another feature of the present invention provides a process for cementing hydrocarbon production wells or water injection wells, comprising several steps. The first step is mixing the cement and fibers. Optionally, additives commonly used when preparing cements for hydrocarbon production wells or water injection wells may be included. The next step is adding an amount of the mix of the previous step to an amount of water to make a slurry. The next step is pumping the slurry obtained from the previous steps through the well liner, filling the annular space between casing and formation. In one other preferred preparation, the procedure is carried out making a regular cement slurry which, as an option, contains additives, and to which fibers are added until a homogeneous slurry is obtained.

### BRIEF DESCRIPTION OF THE DRAWINGS

For better understanding of the purpose of this invention, it has been illustrated in several Figures, which represent the present invention in one of its preferred embodiments.

FIGS. 1a, 1b, 1c and 1d show an outline of a test tube used for perforation tests.

FIG. 2 shows a picture of the test tubes used for perforation tests.

FIG. 3 shows the test tube, cover and the disk on which the perforation slot is made.

FIG. 4 shows a charge layout (22 g hollow type) in the test tube before shooting.

FIG. 5 shows the concrete test tube appearance after carrying out a shooting test according to the Recommended Practice, Standard Procedure for Evaluation of Well Performance, API RP 43, of the American Petroleum Institute.

FIG. 6 shows an FP-02 (0.20/6 fiber) concrete test tube appearance after the disk and ring-type cover of the mold are removed.

FIG. 7 shows the metal disk appearance (left) and the cement disk appearance (right) of the control test tube without fibers, after shooting.

FIG. 8 shows the perforation penetration into the concrete test tube.

FIG. 9 shows the appearance of the cement disk of the FP-02 (0.2% fiber) test tube after perforation.

FIG. 10 shows the subject matter of FIG. 9 enlarged, where distribution and splicing effect of fibers in cement contained in FP-02 (0.2% fiber) test tube can be observed.

FIG. 11 shows the appearance of the FP-04 (0.4% fiber) test tube cement disk after perforation.

FIG. 12 shows the appearance of the FP-06 (0.6% fiber) test tube cement disk after perforation.

### DETAILED DESCRIPTION OF THE PREFERRED EMBODIMENTS

The slurry of the present invention has been designed to bear the extreme demands which a hydrocarbon production well is subject to during its entire service life. The incorporation of fibers into the cement slurry according to the present invention improves its mechanical properties remarkably, especially resistance to tension, impact and shear, optimizing the response of the material to perforation and stimulation operations, as well as to pressure and temperature changes that take place during well production.

In addition, the incorporation of fibers also minimizes shattering and crumbling of the material during perforating operations, increasing bonding between cement and formation.

Fibers may be added to the slurry in a ratio of 0.1 to 0.8% in weight with respect to cement weight. It is preferable to use polypropylene fibers in a ratio of 0.4% p/p(?), between 10 and 15 mm long. The slurry of the present invention may include any kind of fiber such as polypropylene, polystyrene, carbon, alkali-resistant glass and cellulose fibers, without altering the spirit and scope of this invention.

Fibers may be added into any kind of slurry typically used in cementing operations. The addition of such fibers into the slurry does not significantly after its rheological properties, its fluid loss and friction resistance properties, maintaining, at the same time, the physical properties required according to the specific characteristics of the well to be cemented.

As an example, when 0.4% polypropylene fibers are used, it is convenient to use conventional friction reducers in the ratios commonly applied for preparing slurries, as they improve fiber dispersion in the cement mass.

In a preferred embodiment, the slurry of the present invention includes a ratio of between 0.3% and 1.5% in weight with respect to cement weight of a dispersant, e.g. sulfonated naphthalene; between 0.3 and 1.5% in weight with respect to cement weight of a fluid loss agent, e.g. FC 22 copolymer, between 0.5 and 4% in weight with respect to cement weight of an accelerator, e.g. ClCa (?CaCl); between 5 and 20% of latex, e.g. ethylene butadiene, between 0.05 and 0.5% in weight of a retarder, e.g. sulfonate-based retarders; between 5 and 20% in weight with respect to cement weight of a slurry extender, such as hollow glass microspheres; between 38 and 160% in weight of water with respect to the cement weight; and between 0.1 and 0.8% in weight with respect to cement weight of a fiber, such as a 12.7 mm-long polypropylene fiber.

One skilled in the art will understand that the kind, amount and length of fibers may be modified according to the characteristics of the oil well without altering the spirit and scope of this invention. For example, the preparation previously mentioned is adequate for use in an oil well whose temperature does not exceed the Tg (glass transition) (120° C.) of polypropylene.

Fibers may be added either dry, mixed with cement and with the remaining solid additives of the slurry, or moist, adding it into the mix water. For the case of polypropylene fibers, it is recommended to add fibers to cement or directly to the slurry once the cement and water have been mixed. Adding these fibers directly to water may, in some cases, cause problems while mixing, due to foam generation.

It is apparent that the manner in which fibers are added to the slurry depends on the type of fiber used. In effect, the purpose is to obtain a uniform dispersion and mix of the different compounds used in the slurry.

Mixing and pumping slurries with fibers according to the present invention in the production well is performed following the same procedure and equipment used for conventional slurries. The presence of fibers may generate alterations in the flow meter indications; therefore, it is recommended to check such readings against measurements at the storage tanks.

With the purpose of evaluating the behavior of the slurry of the present invention while perforating, tests were performed the API RP 43 procedure (‘Standard procedure for evaluation of well perforators’ of the American Petroleum Institute (API)) for perforation charge tests, with API analysis of: the shattering and crumbling damages caused by detonation; the bonding between cementing and formation; the mechanical properties of the slurry, and the perforation penetration depth.

A description of the testing procedure to evaluate cement behavior in presence of fibers of the invention, with impact investigations, is presented as follows. These tests were performed following a procedure similar to that described in the Recommended Practice, Standard Procedure for Evaluation of Well Perforations, API RP 43, of the American Petroleum Institute.

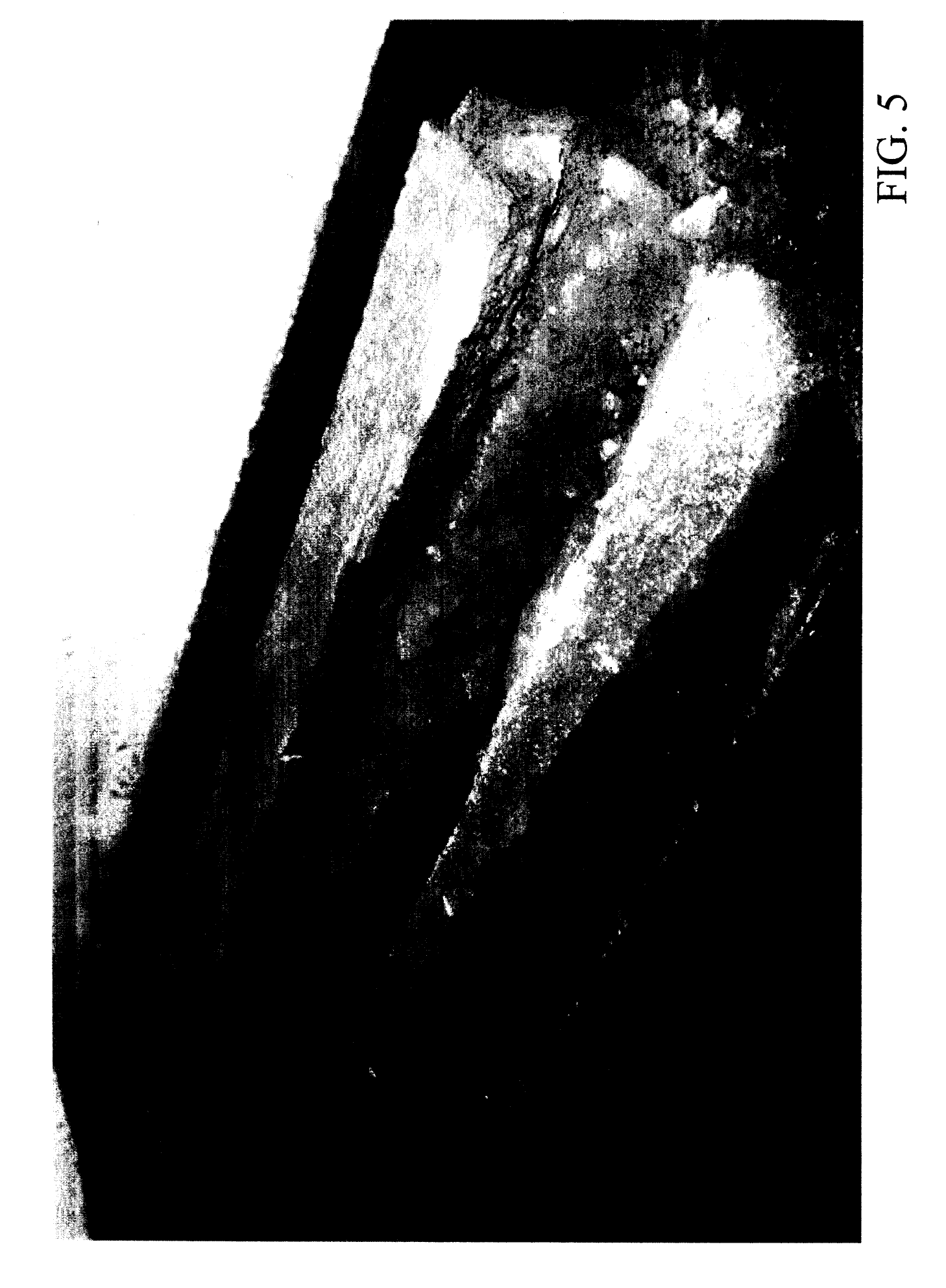

With the purpose of evaluating charge efficiency, tests were made with concrete tube tests. After charge blasting, the perforation hole penetration was observed to exceed the test tube length in 30 inches (≈75 cm). FIG. 5 shows that the concrete located at the end of the test tube where the shot was made had severe damage caused by the impact, demonstrating that the charges were effective for the perforation tests to be performed with test tubes prepared with slurries of the present invention.

When the results of perforation tests performed as described in the Example 1 below were analyzed, it could be observed that, when removing the cylinder mold corresponding to the control test tube, the cement portion (hereinafter called ‘cement disk’) was not bonded to the concrete. The cement evidenced a large number of cracks in the radial direction and a significant amount of material missing from the perimeter area of the perforation hole. Cement in that area crumbled easily.

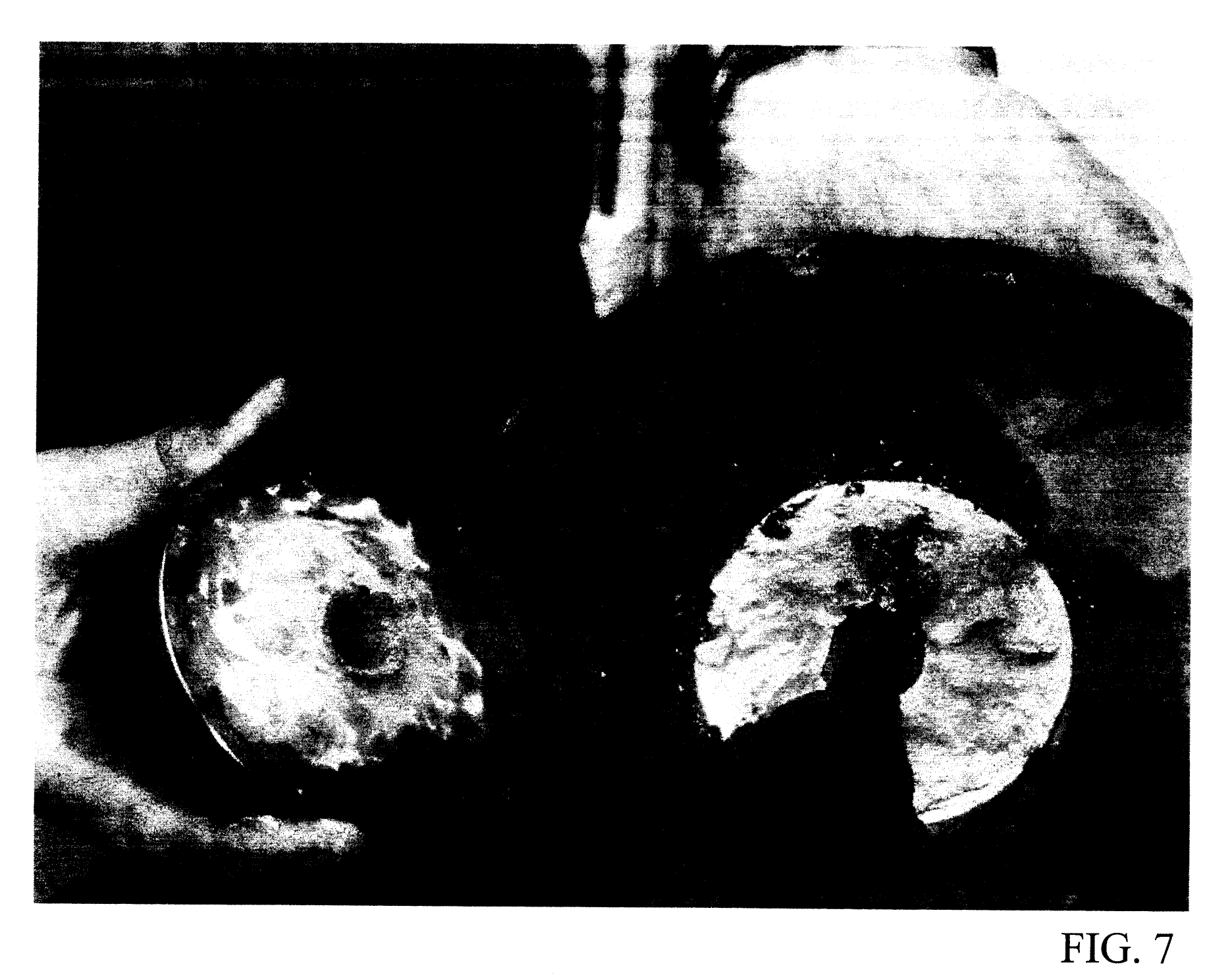

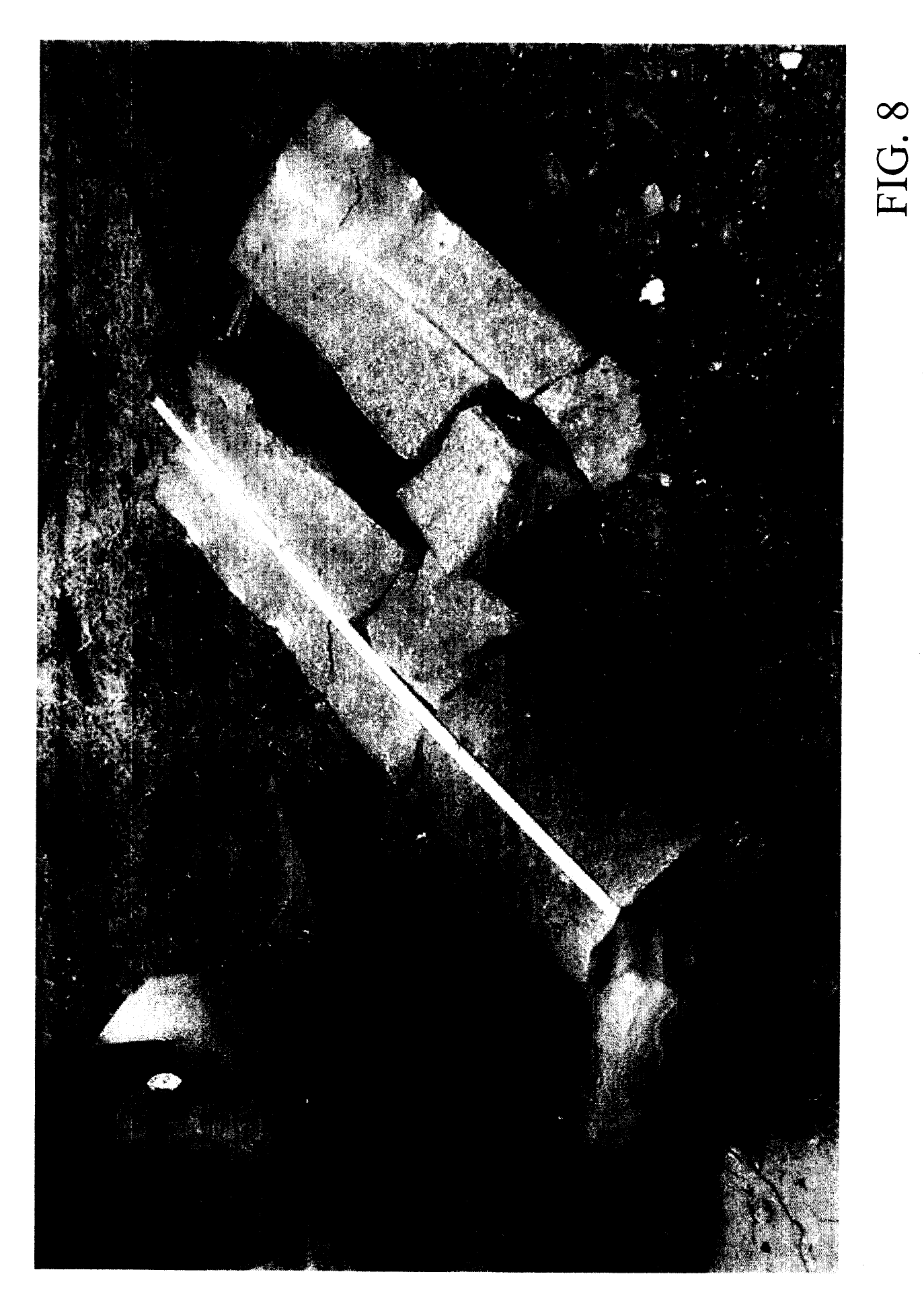

When the cement disk was removed, it could be observed that cracks went all through the cement thickness and that cement looked shattered (FIG. 7). Also, the perforation penetration measured from the side of the disk contacting the metal cover up to the end of the hole was 20.5 inches (50.8 cm) (FIG. 8).

When the cylinder mold of the FP-02 test tube of the present invention (which contained a 0.2% polypropylene fiber weight with respect to cement weight) was removed, it could be noticed that the cylinder disk could be manually detached from cement. Like the control test tube, radial fissures were observed, though no loss of material or crumbling was noticed in the perimeter area of the perforation hole.

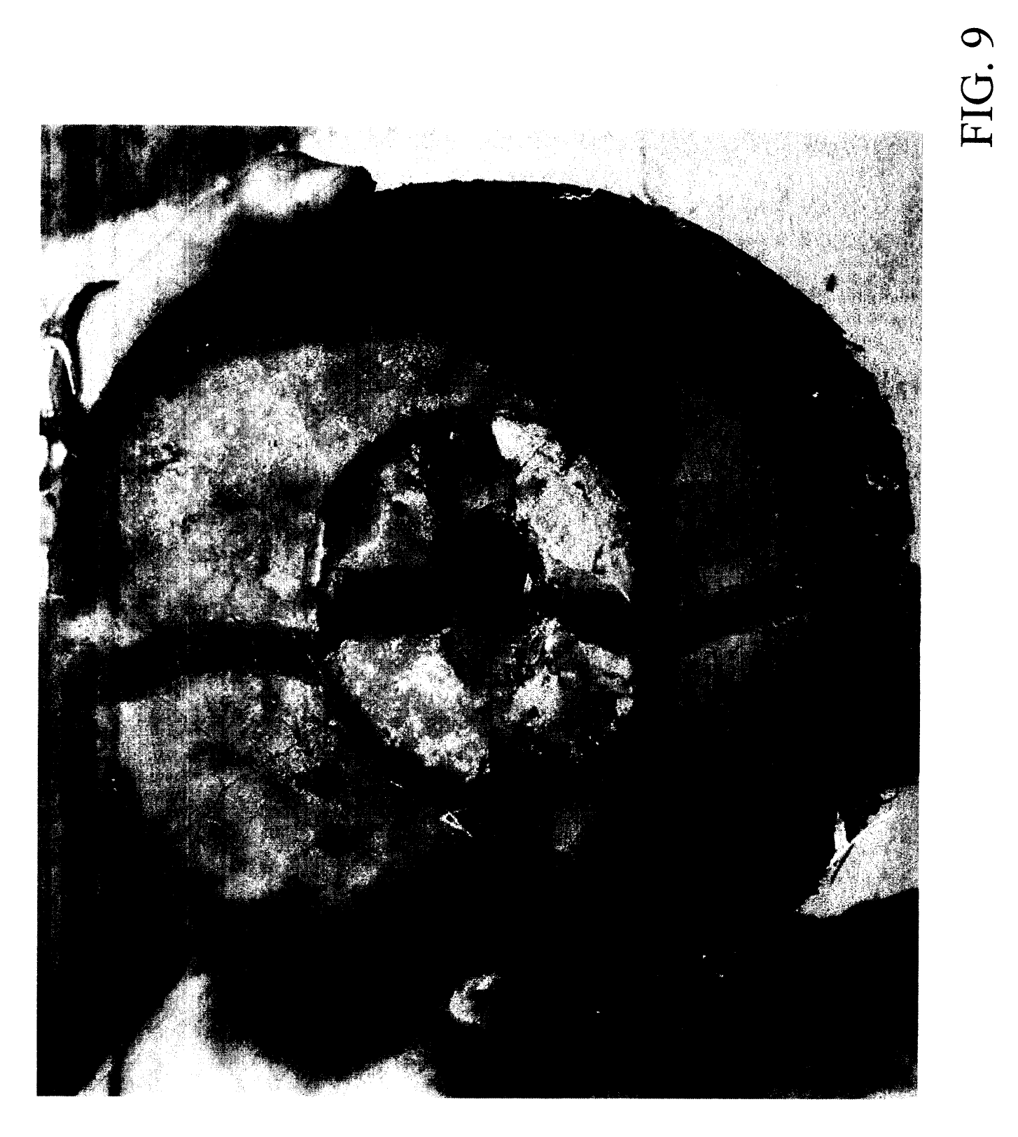

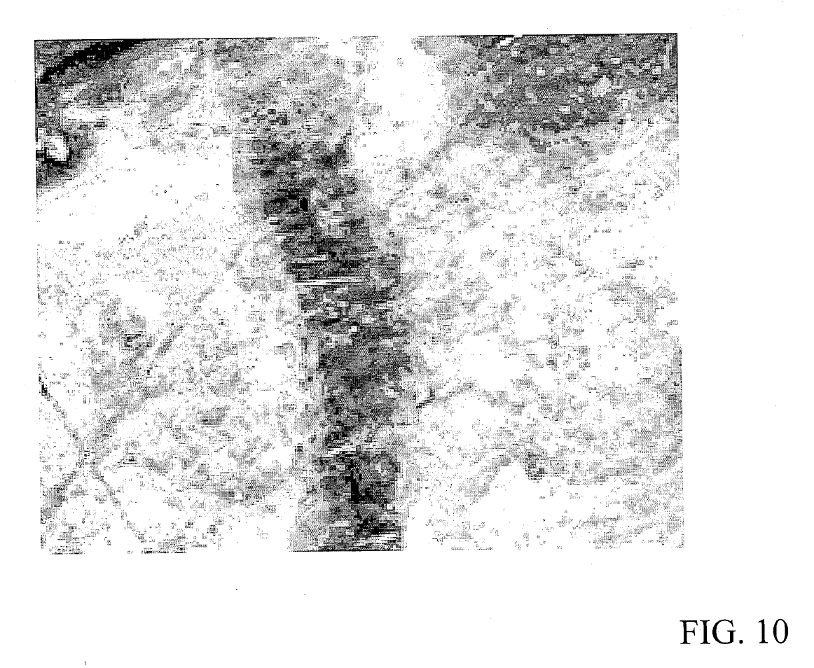

In order to observe fiber distribution in cement, the disk was split by hitting it in the direction of one of the cracks, and its appearance is shown in FIG. 9. The disk is shown after being intentionally cracked in two to observe the distribution of the fibers contained inside. FIG. 10 (FIG. 9 enlarged) shows that fibers were uniformly distributed in the cement mass and, in presence of cracks, they achieved linking or cohesion of the parts (splicing effect) and avoided crumbling of the cement. In this case, perforation penetration was 20.5 inches (50.8 cm).

The analysis of the FP-04 test tube (which contained 0.4% polypropylene fibers weight with respect to cement weight) showed that the disk was strongly bonded to the concrete, as it had to be detached with tools. This has a particular significance, as it evidences the effect of perforation on bonding between cement and formation. The incorporation of increasing amounts of fiber into the slurry improves cement to formation bonding.

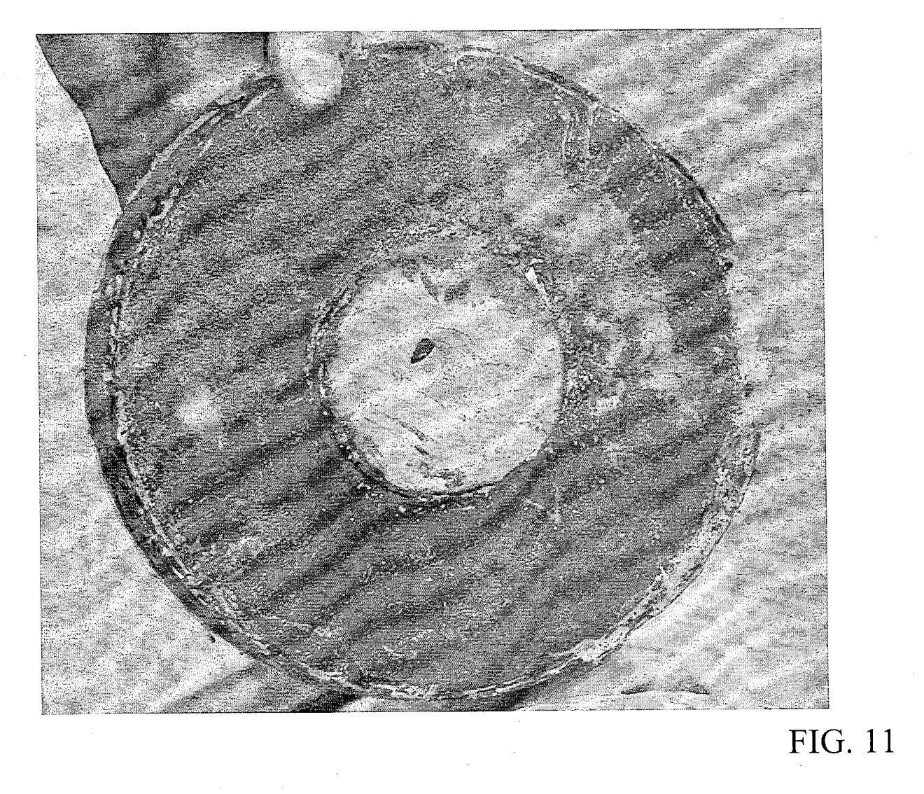

When the cement disk is detached, a lesser number of radial cracks could be observed, as compared to the FP-02 test tube. Cement in the perimeter area of the perforation hole was intact and no cracks were observed in that area (FIG. 11).

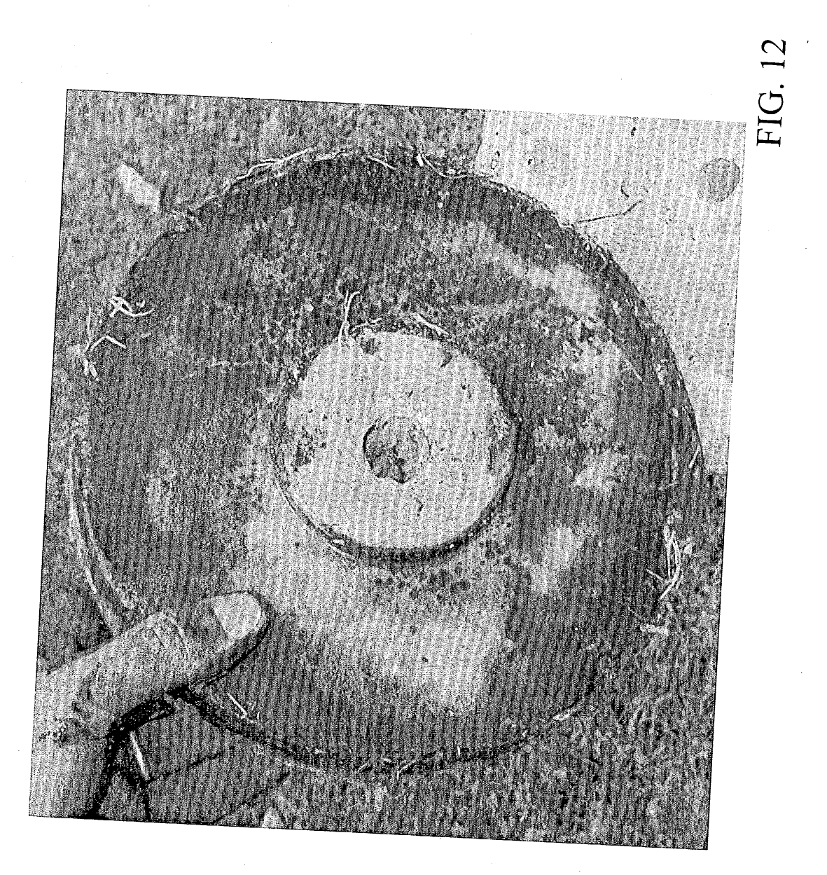

Cement behavior in the FP-06 test tube was similar to that observed in the FP-04 test tube. The cement disk was firmly bonded to concrete and no significantly thick cracks or noticeable damages were observed in the area close to the perforation hole. (FIG. 12).

Studies were also performed to determine compressive strength of cement containing fibers according to the invention, and control cements without fibers. The results are described in the following table:

TABLE 1
Results of compressive strength of cements prepared
with the slurries of the invention:

Compression Strength

| Test Tube | Mpa | Psi |
|---|---|---|
| Control | 35.4 | 5126 |
| FP-02 | (*) (?) | (*) (?) |
| FP-04 | 34.3 | 4967 |
| FP-06 | 33.9 | 4909 |

These results show that the incorporation of fibers into the cement generates a slight decrease in the compressive strength levels, which proved to be 3.1 and 4.2% in FP-04 and FP-06 cements, respectively.

In summary, regarding the perforation tests performed on slurries according to the present invention, it is possible to conclude that:

The slurry containing 0.6% fiber tends to form balls when mixture is made as per API procedure (Recommended Practice for testing well cements, Sec. 5). This phenomenon was not observed in slurries containing less fiber.

The incorporation of fibers (up to 0.6% with respect to cement weight) does not significantly after cement compressive strength;

The incorporation of fibers to cement does not reduce depth of penetration of the perforation; and

The fibers distribute uniformly in the cement mass and, in the presence of cracks, they work to link the parts (splicing effect), avoiding crumbling of the material.

The incorporation of fibers into cement reduces cracking and maintains the integrity of the material in perimeter zone of any perforation hole.

The incorporation of increasing amounts of fibers into the slurry improves cement bonding to the formation.

According to the results of these examples, where 12.7 mm-long polypropylene fibers were used, the optimum amount of fiber is 0.4% in weight with respect to cement weight.

Some of the previous attempts to improve slurry elasticity to cement hydrocarbon production wells have included the incorporation of latex-based additives. The inventors have carried out experiments described below that indicate the superiority of cements containing fibers of the invention as compared to those containing latex.

The following Table shows the comparative results of the mechanical tests performed:

TABLE 2
Mechanical Properties of Type-G oil cements with the
incorporation of different additives.
Mechanical Properties of Type-G oil cements with the
incorporation of different additives.

| | Compressive | Young Module | Poisson |
|---|---|---|---|
| Kind of cement | Strength (Mpa) | E (Gpa) | Coefficient |
| Without additives | 35.9 | 21.3 | 0.25 |
| 0.4% of fiber* | 48.3 | 28.0 | 0.27 |
| 10% of latex* | 38.8 | 18.4 | 0.21 |

*percentage in weight respect to cement weight

The slurry of the present invention evidences higher compressive strength and improved elasticity as compared to the slurry containing latex.

### EXAMPLE 1

### Behavior Assessment when Perforating a Slurry Reinforced with Fibers of the Invention

Preparation of the slurry. The slurry was prepared according to the API procedure: “Recommended practice for testing well cements, Section 5, Preparation of Slurry.” Fibers were incorporated into water to facilitate mixing with solid materials.

The following Table shows the proportions of each solid material used when preparing the slurry:

TABLE 3
Proportion of materials for slurries used in tests:

| Test | Materials | Dosage |
|---|---|---|
| Control | Type “G” Comodoro Cement water ratio | 44% |
| | Fluid Loss Agent-type FC 22 | 0.4% |
| | Friction Agent-type FT 4 | 0.4% |
| | Polypropylene fiber | — |
| FP-02 | Type “G: Comodoro Cement-water ratio | 44%* |
| | Fluid Loss Agent-type FC22 | 0.4%* |
| | Friction Agent-type FT4 | 0.4* |
| | Polypropylene fiber, length: 12.7 mm | 0.2* |
| FP-04 | Type “G” Comodoro Cement-water ratio | 44%* |
| | Fluid Loss Agent-type FC22 | 0.4%* |
| | Friction Agent-type FT4 | 0.4* |
| | Polypropylene fiber, length: 12.7 mm | 0.4* |
| FP-06 | Type “G”Comodoro Cement water ratio | 44%* |
| | Fluid Loss Agent-type FC22 | 0.4%* |
| | Friction Agent-type FT4 | 0.4* |
| | Polypropylene fiber, length: 12.7 mm | 0.6* |

*expressed as weight ratio respect to cement

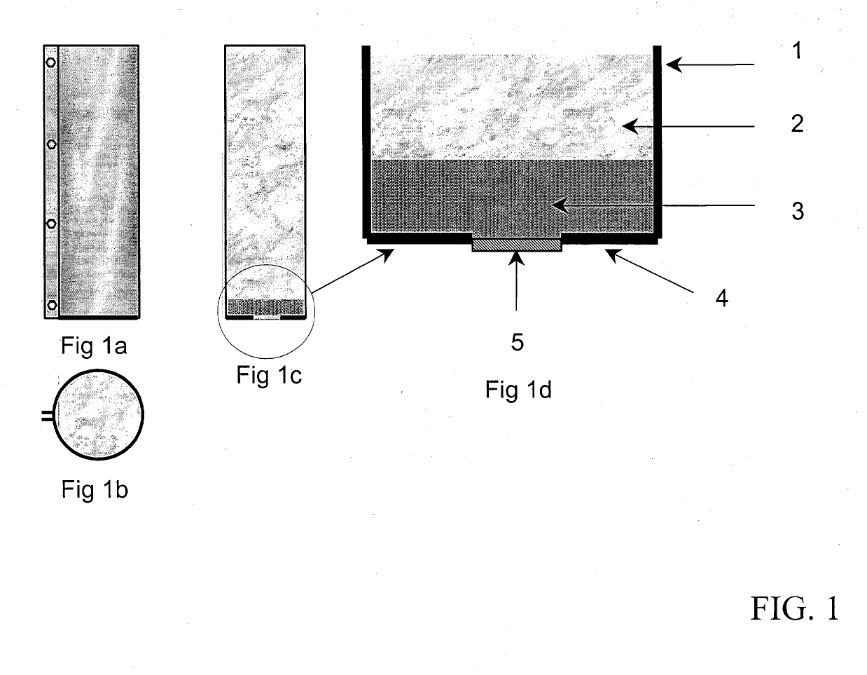

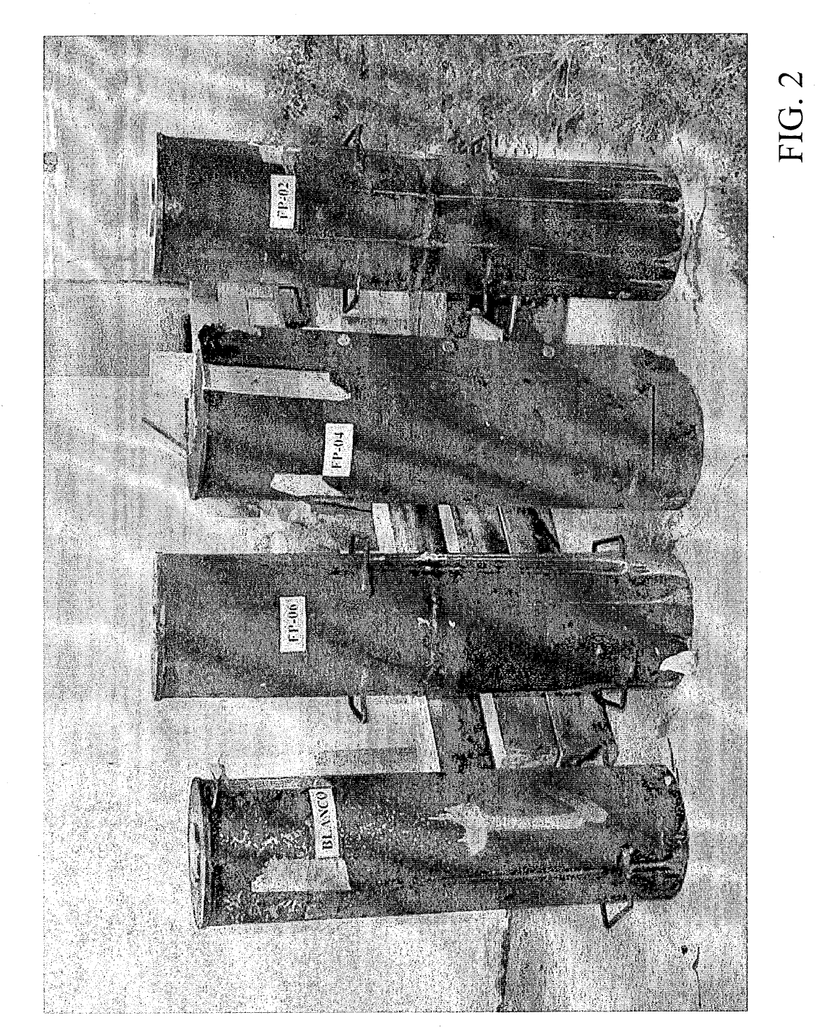

Characteristics of test tubes used in tests: Test tubes were prepared using metal molds of approximately 30 inches in length (76.2 cm) and 8 inches (20.3 cm) in diameter (see FIGS. 1a-1d and 2). FIG. 1a is an overhead view of the mold, FIG. 1b is an overhead view in plan of the test tube, FIG. 1c is a side cross-section view of the test tube, and FIG. 1d is the detail shown in the side cross-section view of FIG. 1c, where 1 represents the mold, 2 represents the API-type concrete, 3 represents cement with fibers of the present invention, or control cement without fibers, 4 represents the ring-type cover and 5 the 1020 SAE disk.

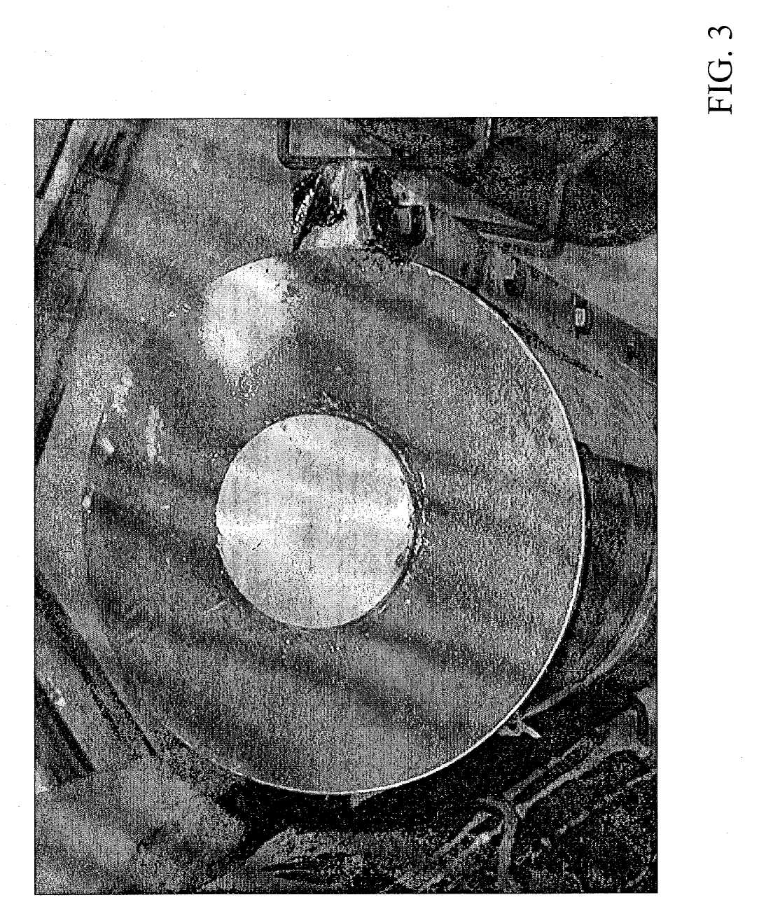

The molds had a flange closure to facilitate test tube removal after perforation test. One of ends of the mold had a cover that consisted of a metal ring with a 3.5-inch (8.89 cm) diameter opening. That opening was covered by a ⅜-inch (9.52 cm) thick metal disk (SAE 1020) through which the shot was made (FIG. 3). The thickness and chemical composition of the steel of the disk were similar to those used in well casings.

Perforation Test: Tests were performed according to API's RP 43 “Standard procedure for evaluation of well perforators.” Mold filling with the different slurries described in Table 1 was carried out straining, firstly, 5 cm (˜1600 cm³) of slurry and completing the mold volume (≈24000 cm³), 24 hours later, with API concrete. The slurries were dried for a period of 7 days, under ambient temperature and pressure.

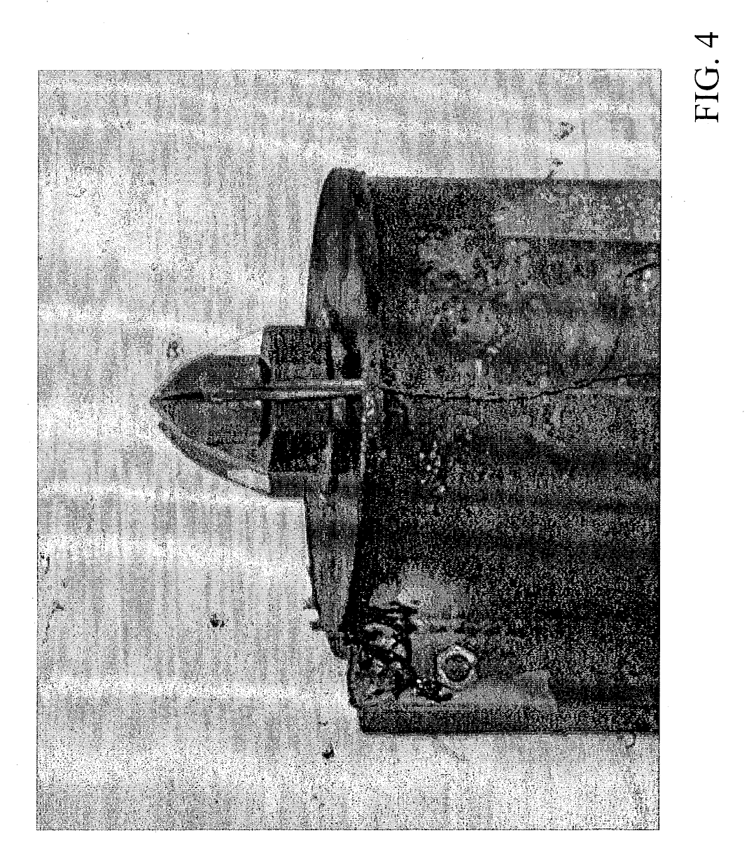

The perforation charge tests were carried out in a bunker for explosive tests. 22 g hollow charges were used, detonated at “zero distance” (separation between charge and casing) (FIG. 4).

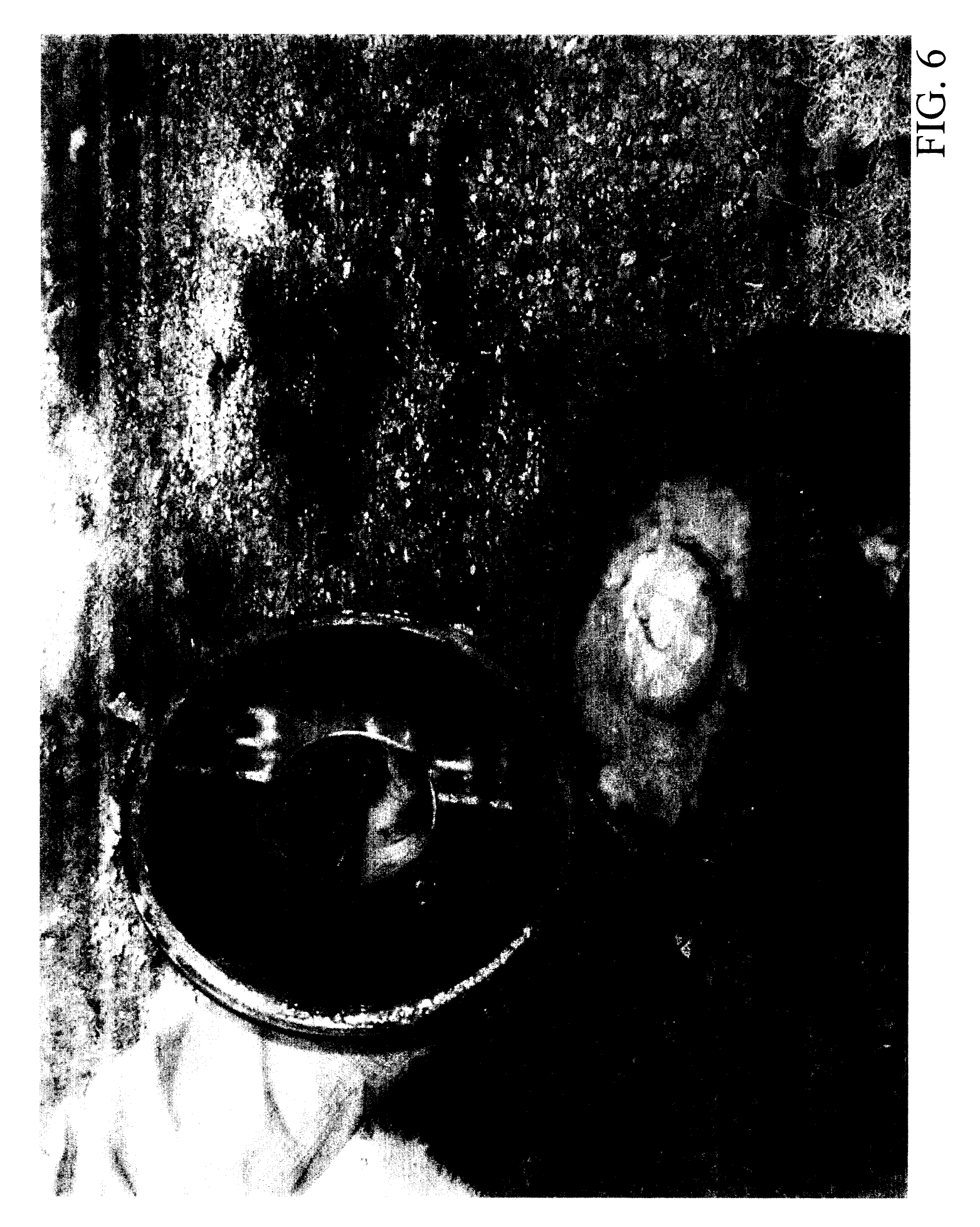

Once the test was completed, the test tubes were removed, detaching first the perforated disk and the ring cover, in order to leave cement exposed (FIG. 6). The rest of the cylindrical mold was removed loosening the lateral flange in order to release the cast made of cement and concrete.

Behavior of concrete related to perforation: Before carrying out the tube perforation tests, concrete behavior related to perforation was evaluated. Five prismatic test tubes with standard 4 inch×4 inch×30-inch (≈10×10×75 cm) dimensions were built and the test was performed as per the API RP 43 standard.

### EXAMPLE 2

### Evaluation of the Compressive Strength of the Slurry of the Present Invention

The mechanical properties of cements were evaluated testing compressive strength of 50-mm-sided cubic test tubes. These tests were carried out at the Centro de Investigation y Desarrollo en Construcciones (CECON) (“Construction Research and Development Center”) of the Instituto National de Tecnologia Industrial (INTI) (“National Institute of Industrial Technology”) of Argentina.

The tested slurries had the dosage described in Table 3 of the Example 1. Test tubes were dried for 24 hours in a curing chamber at 90° C. and 3000 psi, following the temperature and pressure indications of section 7.7. of “Well simulation compressive strength test” of (? Source of Test Procedure) at 1.3° F./100 ft (2,4° C./100 m) temperature gradient.

### EXAMPLE 3

### Compared Evaluation of the Compressed Strength of the Slurry of this Invention

In order to compare the slurry of the present invention with other methods used in the former procedure such as adding latex, 50 mm-sided cubic test tubes were prepared with the following material portions (Table 4)

Portion of materials Table 4 in the slurries used for comparative tests

| Test Tube | Materials | Proportion |
|---|---|---|
| Control | Type “G” Comodoro Cement Additive | 44.%* |
| | | — |
| With Latex | Type “G” Comodoro Cement | 34%* |
| | Latex additives (styrene isobutylene) | 10%* |
| With fibers | Type “G” Comodoro Cement | 44%* |
| | Polypropylene fiber additive | 0.4%* |
| | Length: 12 mm | |

*expressed as weight percentage respect to cement sage of materials (Table 4).

Test tubes were dried for 24 hours in a chamber at a temperature of 84° C. and 3000 psi pressure, following the API RP 10 procedure.

The compressive strength tests were again performed at INTI's (“National Institute of Industrial Technology” CECON (“Construction Research and Development Center”). For such tests, plywood was placed upon the charges in order to avoid concentration of stress. Tests were made according to the ASTM C-195 standard.

### EXAMPLE 4

### Comparative Evaluation of Compression Elasticity Module and Poisson Coefficient in the Invention Slurry

Three test cubes were prepared as described in the Example 3, being then tested to determine the compression elasticity modules and the Poisson coefficient. Tests were performed according to the ASTM C-195 standard. In this case, 6-mm-long, HMB 6/120XG11 model strain gauges were used, which allow obtaining longitudinal and transverse deformations simultaneously. These strain gauges were placed in pairs inside the test tubes, on opposite faces.

In order to compensate for deviations generated by changes unrelated to the test (ambient temperature, strain gauge heating due to current circulation, etc.) one of the samples was used as a “compensating” one.

The present invention has been illustrated by the foregoing examples, which should not be construed as a limit to its scope. On the contrary, it should be made clear that, those experienced in this field may resort to such other performances, changes and equivalences of the invention as the reading of this description may suggest to them, without disregarding the spirit of this invention and/or the scope of the attached claims.

What is claimed is:

1. A slurry for well cementing containing cement and water, and further comprising at least an amount of fibers in a ratio of 0.1 to 0.8% in weight with respect to cement weight.

2. The slurry of claim 1 wherein the well is a hydrocarbon production well.

3. The slurry of claim 1 wherein the well is a water injection well.

4. The slurry of claim 1, further comprising additives selected from a group consisting of dispersants, fluid loss agents, accelerators and retarders, slurry extenders, latex and combinations of these.

5. The slurry of claim 4, further including a dispersant in an amount of between 0.3 and 1.5% in weight with respect to cement weight.

6. The slurry of claim 4, further comprising a Fluid Loss Agent in an amount of between 0.3 and 1.5% in weight with respect to cement weight.

7. The slurry of claim 4, further comprising an accelerator in an amount of between 0.5 and 4% in weight with respect to cement weight.

8. The slurry of claim 4, further comprising latex in an amount of between 5 and 20% in weight with respect to cement weight.

9. The slurry of claim 4, further comprising a retarder in an amount of between 0.05 and 0.5% in weight with respect to cement weight.

10. The slurry of claim 2, further comprising a slurry extender in an amount of between 5 and 20% in weight with respect to cement weight.

11. The slurry of claim 1, wherein the fibers are selected from the group which consists of polymeric, polypropylene, polystyrene, carbon, alkali-resistant glass and cellulose fibers.

12. The slurry according to claim 11, wherein the fiber comprises a polypropylene fiber with a length from about 10 to about 15 mm.

13. A process to cement an annular space between a casing in a well through a subsurface formation using a composition of cement, water and an amount of fibers in a ratio of 0.1 to 0.8% in weight with respect to cement weight, comprising the steps of:
a) mixing the cement and fibers;
b) adding an amount of the foregoing mix to an amount of water in order to prepare a slurry; and
c) pumping the prepared slurry through the well to fill the annular space between the well casing and the formation.

14. The process of claim 13, wherein the well is a hydrocarbon production well.

15. The process of claim 13, wherein the well is a water injection well.

16. The process of claim 13 further including the step of mixing selected additives from the group consisting of dispersants, fluid loss agents, accelerators, and retarders, slurry extenders, latex and combination of these with the cement and fibers.

17. The process of claim 13 wherein the fiber is selected from the group which consists of polymeric, polypropylene, polystyrene, carbon, alkali-resistant glass and cellulose fibers.

18. The process according to claim 7 wherein the fiber is a polypropylene fiber with a length of 10-15 mm.

19. A process to cement an annular space between a casing in a well through a subsurface formation, using a composition of cement, water and an amount of fibers in a ratio of 0.1 to 0.8% in weight with respect to cement weight, comprising the steps of:
a) incorporating the fibers into a first slurry of cement and water until a homogenous slurry is obtained; and
b) pumping the homogenous slurry through the well to fill the annular space between the well casing and the formation.

20. The process of claim 19 wherein the first slurry further includes selected additives from the group consisting of dispersants, fluid loss agents, accelerators and retarders, slurry extenders, latex and combinations of these.

21. The process of claim 19 wherein the well is a hydrocarbon production well.

22. The process of claim 19, wherein the well is a water injection well.
